(19) United States
(12) Patent Application Publication
(10) Pub. No.: US 2015/0294370 A1
(43) Pub. Date: Oct. 15, 2015

(54) Target Area Based Monetization Using Sensory Feedback

(71) Applicant: ntangle labs, inc., Pleasanton, CA (US)

(72) Inventor: Nagendra Nagarajayya, Pleasanton, CA (US)

(73) Assignee: ntangle labs, inc., Pleasanton, CA (US)

(21) Appl. No.: 14/747,514

(22) Filed: Jun. 23, 2015

Related U.S. Application Data
(63) Continuation-in-part of application No. 13/081,605, filed on Apr. 7, 2011.

(51) Int. Cl. G06Q 30/02

(52) U.S. Cl. CPC G06Q 30/0269; G06Q 30/0275; G06Q 30/0277

(57) ABSTRACT

A system and method to engage the user mind by communicating sensory feedback from a client device to a server device, responding with output that is semantically related to the sensory input feedback and rendering the responded output contextually so as to engage the user mind. The sensory input feedback can be visual input while the responded output can be as simple as an advertisement.

### CROSS-REFERENCE TO RELATED APPLICATIONS

This application is a continuation-in-part of the U.S. patent application Ser. No. 13/081,605, titled “Target Area Based Content and Stream Monetization Using Feedback”, filed Apr. 7, 2011 by the applicant. This application is related to U.S. patent application Ser. No. 12/344,747, titled “Time based targeted advertising” filed Dec. 29, 2008 by the present applicant. This application is related to U.S. provisional patent application No. 61/322,899, titled “Target Area Based Content Monetization” filed Apr. 11, 2010 by the applicant. This application is related to U.S. provisional patent application No. 61/325,356 titled “Target Area Based Stream Monetization Using Feedback” filed Apr. 7, 2011 by the applicant. This application is related to U.S. provisional patent application No. 62/016,091, titled “Target Area Based Monetization Using Sensory Feedback” filed Jun. 23, 2014 by the applicant. The above application are hereby incorporated by reference in their entirety for all purposes.

### FIELD

The present disclosure relates to displaying advertising in targeted areas on a client device with a sensory feedback.

### BACKGROUND

Advertising is a communication medium allowing a product or a service to be sold. Advertising enables creation of brand loyalty and increasing brand awareness. Advertising media can be television, newspapers, Internet, radio, cinema, magazines, billboards, etc. Advertising can be traced to early periods, as early as the Egyptians advertising on papyrus. Early advertising was more pictorial than text as the general populace could not read and write, but the printing press changed advertising, people became more knowledgeable and could read and write. Advertisements became part of newspapers, magazines, radio, televisions, and the like.

With the introduction of computer systems and the development of the Internet such technologies became an important part of marketing strategies. Internet companies now rely on this medium as their revenue model. Advertising on the Internet or on a network can text and graphics with sound. Text advertising is usually some text followed by a link so that when a user clicks on the link, the user is transferred to the advertiser site. Text enables relevant advertising to be shown that corresponds to the context of a page or a search. Images are can be shown as banners and can be used to increase brand awareness. Text associated with images can be used to increase the relevancy of the banners or images shown. The text in such advertising is usually static, while images can be grouped together to create exciting dynamic content.

The advertisement and content on the Internet is conventionally viewed through a browser application. The text and images are formatted via HTML. HTML is a tag language and is generally used to describe the content. HTML can also be associated with JavaScript. JavaScript allows dynamic actions to be associated with the tag language and can also be used to provide a rich experience. Advertising, similar to what is seen on televisions, can be enabled per-page with media and sound.

Advertising is sold either by allocating space on a page to show banner images or text links or embedding rich media clients, etc. The advertisements are downloaded from servers and displayed in the allocated space. Online Newspapers, Magazines, Blogs, etc. make money selling these spaces to advertisers. This disclosure describes a new way to add to the monetization revenue per page by providing these content providers to sell any content on the page as advertising.

With the advent of mobile smart phones, smart televisions, smart cars, and the like, streaming media, images, and the like can be selected by the user for viewing, and content from the server side can be monetized by inserting advertising before the start of an event or at the end of the event or by showing overlaid or in-banner advertisements, etc. The whole idea of these advertisements is to attract user attention. But there is no easy way for the user to directly interact with the streaming content so as to get more information about an item that the user is interested in, like the baseball glove, bat, hat, shoes or in case of celebrities their handbags, sunglasses, shoes, clothes, jewelry, etc.

In view of the foregoing, a need exists for an improved system and method for target area based monetization using sensory feedback in an effort to overcome the aforementioned obstacles and deficiencies of conventional systems.

### BRIEF DESCRIPTION OF THE DRAWINGS

FIG. 1 is an illustration of the advertisement system.

FIGS. 2, 3 and 4 depict portions of a flow chart illustrating the flow of information between the client and server device once the user of the client device interacts with the system.

FIGS. 5, 6, 7, 8 and 9 depict portions of a flow chart illustrating the flow of processing on the server device once the client device communicates contents and the user feedback.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

In one embodiment, this disclosure describes a new way to allow the user to interact directly with content with sensory feedback; select interested objects like a baseball glove, bat or a celebrity sunglasses, bags, etc. so that the system is able to get relevant content in real time to keep the attention of the user and maybe induce the user to buy them.

Advertising on the Internet is diverse—from videos to banner images to text based ads. With the advent of smart phones, smart televisions, smart cars the user interacts with the device to stream content from a server device. The present disclosure relates to displaying advertising in targeted areas on the client device with a sensory feedback. The sensory feedback can enable dynamic content to be streamed from a server device to the client device. The targeted areas that enable feedback on the client device enables relevant streaming content and user generated content to be monetized.

This disclosure builds upon the parent patent application Ser. No. 13/081,605 entitled “Target Area Based Content and Stream Monetization Using Feedback” and describes an innovative way to engage the user with contextual content like an advertisement or game or puzzle, etc. when a sensory feedback is communicated back to the server device.

Embodiments of the present disclosure are described herein in the context of a method and apparatus for emulating a competitive process. Those of ordinary skill in the art will realize that the following detailed description of the present disclosure is illustrative only and is not intended to be in any way limiting. Other embodiments of the present disclosure will readily suggest themselves to such skilled persons having the benefit of the disclosure. Reference will now be made in detail to the implementations of the present disclosure as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In accordance with the present disclosure, the components, process steps, and/or data structures can be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, can also be used without departing from the scope and spirit of the inventive concepts disclosed herein.

A number of terms are used herein to describe features of embodiments of the present disclosure.

As used herein, the term “advertisement” will be used to refer to any of a number of formats (known and to be developed) for showing content to an operator or user or viewers or customer, and the like. As used herein, the term “advertisement” may be used to refer to the content shown on a client device display. The content may include text, graphics, media streams, sound, sensory inputs/outputs, etc. The advertisement may include a title, image, description, a visual link and an actual link to transfer control on a click, etc.

As used herein, the phrase “computer system” can refer to a system that can comprise a processor, memory, storage, network, clock, input devices and output devices. Input devices can comprise a keyboard, a pointer device such as a mouse, touch screen, or the like. Output devices can comprise one or more display, printer, plotter, and controller, or the like.

The brain of a computer system can comprise a processor such as a microprocessor. In various embodiments, a microprocessor can execute machine level instructions that enable it to perform logic as well as communicate with input and output devices that can be associated with the system. The machine level instructions can be executed with dedicated electronic circuits or use a higher level programmable code that enables the microprocessor to execute a task. In various embodiments, the computer system, at startup, loads an operating system (OS) that manages the input and output devices and also enables executing higher level applications.

A server device can be a computer based system that can respond to a client device request. The server device executes a server application that can listen to client requests and respond back with a response. A client device can be a computer based system that communicates across a network 140 with a server device for content.

The client device can be a thin client or a thick client. For example, in some embodiments, a thin client device does not handle much processing other than collect input send it across to the server for processing and output the response from the server onto the output devices on the client, like a display, and the like. In further embodiments, a thick client device can run an operating system itself, do more processing and communicate with the server device as needed. The communication is can be handled by higher level applications being executed on the client device which can make use of networking means to communicate.

As used herein, the phrase “client device” 120 can refer to a device used by a user to view an advertisement. The phrase “client device” has also been used broadly to refer to embodiments wherein client applications execute on the device. The client device can be a computing system comprising one or more of a processor, storage, network connectivity, display, and the like.

In various embodiments, the client device executes a client application, (e.g., a browser) that can communicate across a network with a server device and retrieve content. The retrieved content can be shown on the client display. The browser can also execute program code such as JavaScript, Java, or the like. Client applications, like the browser, can make use of clock signals generated on the client device to enable timer services allowing program code to be executed at regular intervals.

As used herein, the phrase “server device” 150 may be used to refer to a device that executes a server application waiting to respond to a client request. The phrase “server device” can refer to server applications executing on the server device. On a client request such as a request from a browser, the server application sends back content that can be shown on a browser application. The content can be text, graphics, sound, media streams, and the like. A server device can execute a plurality of server applications, and in an embodiment, a server application might itself act as a client and make requests to other server applications executing on the server device or other server devices on the network. A server device can handle concurrent requests from a plurality of client devices. In an embodiment, a plurality of server devices can appear as one to a plurality of client devices to handle incoming client requests and to scale in performance.

As used herein, the term “browser” 130 can refer to a client application that executes on a client device and connects to a server device. A web browser is an example of such an application (usually referred to as a browser application) that can be used to browse content on the Internet/intranet from a server device. The content can comprise a tag-based language such as HTML but can be others such as XML, XHTML, and the like. The browser can have the capability to show other content.

HTML is a tag based language and uses tags to identify content. An HTML document is organized into sections with a “<begin> and “<end>” tag. It begins with a <HTML> tag followed by a <HEAD> tag (section), followed by a <BODY> tag (section). A body tag acts as a container for other tags like <TABLE>, <DIV>, <SPAN>, <P>, <FONT>, and the like. The browser renders HTML content onto the display device making use of any Cascading Style Sheets (CSS) usually in the HEAD section to format and style the content rendered. HTML enables a viewer to enjoy print quality visuals on the display. HTML can be associated with program code to create rich action oriented applications. A browser usually includes a program code interpreter or provides such a functionality to execute the program code associated with HTML. A browser also makes use of the timer functionality on a client device enabling program code to be executed at timer intervals. Program code sign up for these timer services using convenience function calls, such as settimer(function, delay), setinterval(function,delay) and clearinterval(id).

As used herein, the term “display” can refer to a display device connected to the client device that allows content to be shown. A display can be a piece of electrical equipment usually connected to a video source of the client device. The display can show text, graphics, generate sound, and can be linked to/show sensory outputs, and the like. Display devices can comprise a Liquid Crystal Display (LCD) based device, but can also comprise a Cathode Ray Tube (CRT), Plasma, or Light Emitting Diode (LED) based, air, water, 3D displays, lasers, and the like. Display devices can be part of the client device as in a laptop/tablet/smart phone or separated from the client device as in a desktop computer.

As used herein, the phrase “clock signal” can refer to a timing apparatus and/or software that generates a clock signal periodically on the client device. The client device can offer a low-level Application Programmable Interface (API) enabling an operating system or client device applications to make use of these signals to offer timer services, scheduling, and the like. Timer services can enable program code like shell scripts, application binary code, or at a higher level, an application like a browser with a program code interpreter to offer operating system type of timer services.

As used herein, the phrase “target area” can refer to an area on the display device that can be used to show content. Content can comprise text, graphics, media streams, sound, and the like. In an embodiment, the target area can comprise a <DIV> tag container. A <DIV> tag is part of the HTML tag language. A <DIV> tag container can be very powerful especially with CSS and offers almost the capability of the <BODY> tag. The <DIV> tag is rendered by the browser on to the display device as part of the HTML page being shown on the display device. A <DIV> tag has the following attributes an id, width, height, title, style. The id attribute can be used to target a <DIV> container so that content can be rendered with JavaScript program code without affecting content on other parts of the display device. To render content in an embodiment, the <DIV> tag id is looked up using a convenience method such as getElementByid, and an attribute such as innerHTML to render. Other ways of doing this would be to inject HTML language tags into the Document Object Model (DOM) of the browser application, thereby rendering content onto the display on a refresh. In another embodiments, the target area container can be linked to or a sensory output device enabling sensory content to be displayed or communicated back to the server device. Sensory content can be text, graphics, sound mixed with signals to control changing the intensity of vibrations, color, smell/aroma, touch, feel, thermal, location, movement, etc.

As used herein, the phrase “program code” can refer to code executed in a computer based system. Program code can be in interpreted form or compiled form. In interpreted form the code is at a high level in the form of a programming language and is interpreted one line at a time to execute the code. In compiled form, the program code is analyzed and compiled into a binary form that the computer system can understand and execute as instructions. The operating system of the computer system is usually in compiled form and enables executing applications, tasks, communicate across a network, with input and output devices, and the like. Applications can also interpret program code or compile such code to offer more services. A browser is one such application that allows content to be retrieved from a server device. The content can comprise HTML. The browser can execute a JavaScript interpreter so HTML which is a tag language can be associated with dynamic actions. JavaScript is an object oriented language, allowing HTML to be rendered, managed and manipulated on the display device. JavaScript also enables input, output and communication with a server device. A <script> tag can identify program code to be executed. The src attribute of the <script> tag is a link and can point to a file containing program code to be executed. The browser, while parsing HTML content, on recognizing a <script> tag, can load the program code from the server device and execute the code using the JavaScript interpreter. The code on execution can create new HTML tags, JavaScript objects, render content, sign up with the timer service, and the like.

As used herein, the phrase “data object” can refer to an object with attributes and methods. Attribute is a specification that defines a property and is usually in the form of a name and value pair. Attributes usually have a type and rules for using the type. A type might be integer, long, character or String, Object, and the like. An object of a type integer may allow numbers from 0 to 2̂31-1 to be stored and operated upon. An integer object might be unsigned or signed allowing negative numbers. A character object might store values between 0 and 2̂16-1. A String object might be made up of multiple character objects in sequence. An object method is like a function call but with a namespace and visibility of just the object. Object methods enable manipulating the attributes of the object, like setting or retrieving the attribute value, and the like Objects can be extended or aggregated to form higher level types allowing complex structures to be represented and operated upon as objects. An Address object might have attributes, street, description, city, zipcode, state, and country where street might be a String object, description again might be a String object, city might be a String object, zipcode might be a Zipcode object, state might be State object and country might be a Country object. An Address object is an aggregation of multiple objects, while a Zipcode might be an extension of the String object with addition of another String object. The first String object in a Zipcode maybe named zip, while the second String object maybe named geography. The two attributes allow a Zipcode of the form postcode-geography. Methods of the form get Zip, and storeZip enables retrieving and storing zipcodes.

As used herein, the phrase “click” can refer to a click or change in state of an input device such as a mouse or a joystick button, etc. in a computer based system.

As used herein, the phrase “link” can refer to an URL. URLs are Uniform Resource Locators and are of the form http://login:password@address/context?querystring. Address can be a numeric such as an IP address or a hostname.domainname.com. query string can be of the form “parameter=value”.

As used herein, the phrase “customer” can refer to a customer who creates advertisements on the server device using a client device. The customer pays for the advertisements shown on the client device. The billing may be daily, monthly, prepaid, post-paid, and the like

As used herein, the phrase “fixed price” can refer to a type of advertisement pricing wherein the price of an advertisement to be shown is fixed. The fixed price can be configured on the server device and can be specific to a target area where the advertisement is to be shown. The fixed price can change with demand. A fixed price type can have priority over a bid price type. The priority enables a fixed price advertisement to be shown even if there is a bid price advertisement available and has a higher price. The fixed price guarantees to the customer that it will be shown on the target area.

As used herein, the phrase “bid price” can refer to a type of advertisement price wherein the customer bids with other customers on the price to show an advertisement. The bidding is of a forward auction type.

As used herein, the phrase “cost-sale” can refer to a type of advertisement price wherein the customer does not pay to show an advertisement but pays a commission on the sale of an item resulting from showing the advertisement. The user is transferred to the customer site on a click on a link in the advertisement.

As used herein, the phrase “cost-per-time” can refer to a type of advertisement price wherein the customer pays to show an advertisement for a time period.

As used herein, the terms “impressions, per-click, click-sale, cost-per-time” can refer to the type of billing for an advertisement. An impression is an impression of an advertisement on a client device. Impressions allow billing a customer for showing the advertisement on a client device. The billing could be per impression or one thousand impressions also known as Cost per mil (CPM), and the like. Per-click is a click on the target area where an advertisement is being shown or a click on a link in the advertisement. The click is tracked and allows the customer to be billed. Click-sale is a click followed by a sale of a product being advertised or a product from the customer site. The customer is not billed for the click, but pays a commission as part of the sale. Cost-per-time is a way to increase monetization revenue of a page by selling target areas on a page for time. The time period could be as short as a second to months, etc. The target areas can show contents generated by a site or a partner or a server device.

As used herein, the phrase “query-terms” can refer to parameters passed from the client device to the server device as part of a request for an advertisement. Query terms can be keywords or terms of a search such as city, state, country, adults, children, product, hotel, airfare, vacation, cruise, and the like. The query term enables the server device to match the query-term to an attribute target terms, and the like, in the data objects on the server device and select matching data objects to send back to the client device.

As used herein, the phrase “target-terms” can refer to an attribute in the data object allowing the query-terms parameter sent by the client-device to be matched. The server device on receiving a request, uses an index to find matching advertisement object keys. In an embodiment the index might be constructed by feeding the advertisement objects to an index writer. The index writer breaks down the object attributes such as name, description, target terms into words and adds them to index. The index might be of type inverted index. To match using the index, the server device might use an index searcher that goes through the said index and finds all the documents with words that match the said terms. The matching documents could then be used to retrieve keys to the advertisement objects. The matching objects are then returned by the server and can be included in a response.

As used herein, the phrase “trapping a click in the target area” can refer to capturing a click in a target area or on a link being shown in the target area. A click can be easily captured in the target area through a JavaScript function attached to the <DIV> tag through the onclick attribute. Similarly, a click on a link can be captured through a JavaScript function attached to anchor tag (<A>) onclick attribute.

As used herein, the terms “tracking a click”, “count”, “client attributes” can refer to a click on an advertisement and communicating the said click to the server device. In an embodiment, it can be done by creating an image tag dynamically with the src attribute taking as parameters click id, advertisement id, target area, and the like. The client device sends across the image request back to the server device. The server device logs will reflect the value of the src attribute which can be processed later for billing the customer. Similarly the count value can be transferred back to the server device for billing. Every request usually will have the client attributes, ip address and session id. Additional parameters like affiliate id can also be passed so that affiliate performance can be tracked to enable paying a commission to an affiliate. In other embodiments, a click can be sent across to a server device using an XMLHttpRequest.

As used herein, the terms “sale price”, “discount percentage”, “compare link”, “compare identifier” can refer to a data object with these attributes. The data object with these said attributes are created by a customer on the server device or sent as part of a data feed to the server device. The sale price, discount percentage and a compare link are displayed on the display device along with other attributes. A user click on the compare link is captured and a request is made to the server device address in the compare link along with at least the compare identifier as a parameter. In an embodiment, the server device address can be different from the server device that sent in the initial advertisement data object. The compare identifier enables the server device to send comparison shopping content. Comparison shopping content can be product items with the matching product codes but from different customers with different prices. The comparison shopping content is displayed on the client display. Each product shown on the display could have customer links. A click on these links usually enables the client device to retrieve content from the customer server device allowing a user of the client device to complete a sale.

As used herein, the terms “title”, “description”, “show link”, “click link” can be attributes of a data object shown as an advertisement on the client display device. The title might be shown in a different color compared to the description and the show link attribute, and might be rendered as a link. The “show link” value is usually the shortened meaningful address of the customer server device, while the click link attribute contains the link address of the customer server device to retrieve content from, on a click.

As used herein, the terms “count”, “count threshold” can be attributes of a data object and enable the program code to show a data object on the client display for that many count clock signals. Once the count threshold is crossed, the program code changes the current object to the next object to be shown. A data object usually is a cyclical link list of objects.

As used herein, the terms “Ajax”, “XmlHttpRequest” can refer to the ability of the client application like a browser executing on a client device to communicate with the server device to retrieve content asynchronously. The XmlHttpRequest can be initiated on a clock signal or a count threshold trigger or a click to retrieve content from the server device; said content can be selectively refreshed onto the display device using a tag like <DIV>. Before the availability of XmlHttpRequest, a request by a browser would stop and pause functions until the request was completed. The returned content was updated as a complete HTML page and caused a flicker as well as long waits XmlHttpRequest and selective refresh of the client display enables rich application experience with just HTML and JavaScript.

As used herein, the terms “xsocket-http”, “reverse Ajax”, “Server push” can refer to the ability of the server device to push content asynchronously to a client device. The server device starts the content push based on an initial request for content from the client device and pushes the content on changes or events on the server devices or client devices. Such events on the server side might be timing means like clock signal timers, or a change of state communication from a client device such as a click or input means. Server push eliminates the need for polling the server device for content by the client device using a clock signal. Polling can be expensive in terms of resources used, while asynchronous server push eliminates the cost of these expensive resources.

As used herein, the terms “websockets”, can refer to the ability to communicate between a client and server device in full duplex using TCP communications protocol. Websockets enables port 80, port usually used for browser-server communications and through firewalls to use the http protocol for TCP communications. The TCP communications is layered on top of http protocol with some extra overhead. This is a very useful protocol but is usually not enabled in browsers due to security limitations.

As used herein, the phrase “website” can refer to a server device and a server application 160 on the server device that is able to respond back with content, usually HTML based, but could offer other services like email, cloud computing, ftp, and the like. A website usually has a name or an IP address. If it has a name it is registered with a name registry so that it can be discovered by users on the Internet. The name is usually of the form http/www.name.XXX., where XXX is a Top Level Domain Name (TLD).

As used herein, the phrase “Object converter” can refer to an object converter that allows objects with attributes to be represented as Extended Markup Language (XML) or in JavaScript Object Notation (JSON). XML is a tag language that can be used to describe objects with attributes, schemas, and the like. HTML tag language is nothing else but XML and is used to describe content to be shown on a display device. XML can be used to describe a Java or a JavaScript language object. The advantage of using XML to describe a language object is it makes the object portable across operating systems, computer systems, and also allows objects to be sent across networks. JSON is another way of representing objects and represents object attributes as name, value pairs. Object converter provides methods that allow a language object to be converted to XML/JSON, and from JSON/XML back to the language objects.

As used herein, the phrase “Advertisement server” 170 can refer to a server application on a server device that sends back data objects and program code based on a request. The program code can be script code and in an embodiment can be JavaScript. The data objects are objects with attributes and in a JavaScript embodiment can be JavaScript objects. In other embodiments they can be Java language objects, and the like. An Object converter is made use of to send data objects to a client. One of the parameters of a request is the type of objects, as an XML or JSON object. If a data object is sent as a JSON object, then there is no conversion required on the browser since it is a JavaScript object. The other parameters maybe query terms, affiliate id, client attributes, and the like. The query terms enable the server to select the data objects relevant to the query terms.

Another job of an Advertisement server 170 can be to enable creation of the data objects by customers 185. The customers access the advertisement server using a client device 180 and send parameters to create/modify/manage an advertisement. This enables the advertisement server to send back graphical user content enabling the customer to create data objects with attributes, creating an advertisement. An advertisement can be perceived as a data object, made up of attributes and methods. The data object gets converted into text and graphics on the client device by the program code into a viewable form. The advertisement data object might include attributes target area, fixed or bid type or click-sale, fixed price (read only attribute), bid price, target terms, and the like. The advertisement object further aggregates multiple data objects, . . . as a list. The data objects in the list have at least attributes title, description, show link, click link and a count threshold. The data object attributes may also include price, discount percentage, product code, compare link, compare identifier, image link, and the like. The data objects in the list might be created as a sequence of objects in an embodiment. The sequence allows the objects to be linked creating a cyclical structure. The advertisement object methods traverse the list to return the current object, update attributes, keep track of current object, count of objects, and the like.

The customer creates an advertisement object by choosing a target area on the client device, chooses a price type, —if the price is fixed type, the price to show the data object on the target area is made available by the server device. If it is of bid type, the customer chooses a bid price to pay—creates the data objects with attributes title, description, show link, click link, and the like in sequence, chooses the count threshold for each data object and sets target terms if advertisement is to be targeted towards a set of query terms. In an embodiment, the bid price set by the customer may need to be higher than the minimum bid criteria set for a target area. The customer may also choose that the advertisement server automatically choose a target area to display the advertisement.

In other embodiments, a customer might also create an advertisement object with attributes, product name, description, sale price, discount percentage, product code, show link, compare link, target terms, price type, and the like. The advertisement server converts these attributes into a form as above into a data object with attributes title, description, show link, clink link, compare link, compare id, and the like. The customer instead of creating the advertisement through a graphical user interface might send across the advertisement objects as a data feed or using an Application Programmable Interface (API).

The graphical user interface also enables the customer to group advertisement objects into an advertisement campaign. The advertisement campaign is again a data object with attributes such as a name, budget, a daily spending limit, start date, end date or no end date. The budget attribute limits the advertisement expenditure to a set budget and stops the group of advertisements from being shown once the budget threshold is crossed. The daily spending limit is again a similar threshold limiting expenditure per day. The start date and end date attributes enables the group of advertisements to be shown for the period. A “no end date” shows the group, until budget thresholds are crossed.

A plurality of campaign objects can be created to create groups of advertisement objects. The plurality of campaign objects are grouped under a customer object with attributes such as name, company, address, email, user id, password, and the like. A daily limit attribute in the customer object allows spending expenditure to be limited across campaigns. Payment attributes, such as a credit number, card name, card type, enable customer to be billed for an advertisement.

The graphical user interface also allows the customer to view performance of the campaigns and billing statements. A performance summary shows the daily, monthly, yearly performance of the campaigns by impressions, clicks and charge. The daily and monthly performance summary allows further viewing the details by day, and the like. The campaign performance activity shows performance by campaign, money spent, daily impressions, clicks, charge, and the like. Links allow viewing details by each advertisement and client attributes such as client device address, session id, and the like. Billing statements made to the customer can also be viewed.

Yet another job of an advertisement server is to enable a publisher or a service provider 195 to select target areas on a client display or choose the format of advertising to be shown on the client display. The publisher also connects to the advertisement server through a client display 190. A single or a plurality of advertisements may be shown in a target area. The publisher can choose the number of advertisements, the layout of the advertisement, horizontal layout or vertical layout or line layout, and the like, the size of the layout, width, height, color of the layout, and the like. These can be done programmatically or using the graphical user interface. The publisher injects the generated program code, HTML tags into the HTML content on the publisher website allowing the advertisement to be served on a client request.

As used herein, the phrase “publisher” or service provider can refer to the owner of a website or service on a server device. The publisher owns or has access to the content that is served through the web server or server device. The publisher to monetize the content serves advertisements along with content to be shown on the client device. The publisher in an embodiment embeds these advertisements in the form of text, graphics using tags like <script>, <div> and the like. The advertisements could be just simple text or images or media streams, program code and data objects. The program code and data objects could be retrieved from an advertisement server executing on the same server device or on another server device. The publisher refers to an advertisement server device using the src attribute of the <script> tag, and chooses a target area where the advertisement should be shown on the display device by specifying the id attribute of the <div> tag in an embodiment. The publisher can generate “a bundle” programmatically or through a graphical user interface of the advertisement server that allows the publisher to generate these. In an embodiment the publisher uses a graphical user interface to create “a bundle”. The publisher takes the bundle object and adds it to the content on the server device. In an embodiment, the publisher can use programmable APIs to create “a bundle” and embed the bundle into the content.

As used herein, the phrase “site-owner” can refer to the owner of a server device. The site-owner owns or has access to the content that is served through the web server or server device. The site-owner to monetize the website content serves advertisements along with content to be shown on the client device. The site-owner in an embodiment embeds these advertisements in the form of text, graphics using tags like <script>, <div> and the like. The advertisements could be just simple text or images or program code and data objects. The program code and data objects could be retrieved from an advertisement server executing on the same server device or on another server device. The site-owner refers to an advertisement server device using the src attribute of the <script> tag, and chooses a target area where the advertisement should be shown on the display device by specifying the id attribute of the <div> tag in an embodiment. The site-owner can generate “a bundle” programmatically or through a graphical user interface of the advertisement server that allows the publisher to generate these. The site-owner takes the bundle and adds it to the content. In an embodiment, the site-owner can use programmable apis to embed advertisement into the content. The site-owner also generates content, dynamic or static that is served through the server device and shown on the client device.

A site-owner to better monetize per page revenue can identify target areas on the page and create these target areas on the advertisement server device. The site owner chooses attributes target area type, fixed or bid type, fixed or minimum bid price, billing type cost-per-time, ppc, cpm, cpi, etc., billing freq, billing period in time like seconds, day, month, quarter, year, number of periods, content type like text, text-image, image, video or any, site-owner or partner generated or advertisement server generated content, motion, etc. The site-owner uses a graphical user interface or programmable apis to create these in an embodiment. A target area with site-owner generated content now enables the site-owner to sell any content on a page to an advertiser or a customer. The content does not have to appear as an advertisement but can be prime position close to the title of the page, like a link or content on a button (that is clicked thousands of times) increasing brand awareness, traffic and sales/revenue of the customer/advertiser allowing both the site owner to increase monetization as well as the customer/advertiser. The target areas enable the site-owner to now monetize any part of the page or client device with any content not just advertisements. The target areas can show advertisements from an advertisement server device or site-owner generated content or content from a partner. The content shown in these target areas can be customer/advertiser relevant. The site-owner invites customers to sign up to buy these target areas by time, click or impressions. Site-owner generates Javascript code by creating “a bundle” referring to the target area, choosing display, layout, content type, motion, content generation attributes, etc. for the target area. Site-owner embeds Javascript code into web page showing content on the client device. Site-owner also adds the bundle id to the target area so that the bundle program code can identify the target area to track the target area's performance. The customer is billed based on the billing type and frequency created based on impressions, time, ppc, etc.

As used herein, the phrase “target area type” can refer to the type of a target area on the client device. The target area type can be a link, static-link, banner-line, banner, area, any, etc. in an embodiment. A static-link is any type of URL link that does not change while a link can show dynamic content with motion. A banner-line target area types shows contents on a client device limiting the content to just one line of some width/height. Similarly a banner is an area on the client of some shape showing a banner type advertisement. A banner target area type usually shows a plurality of advertisement objects from a server device changing the advertisement objects with time. A banner can include text/image/sound, etc. An area is a type of shape on the client device that can not only show text/images but stream in media. The target types described are examples of just an embodiment and more target types could be added as needed.

As used herein, the phrase “layout” can refer to the type of a target area layout on the client device. The layout can be horizontal, vertical, line or any in an embodiment. The layout describes the way an advertisement object attributes are rendered in the target area.

As used herein, the phrase “content type” can refer to the type of content to be shown in the target area. The content can text, text-image, image, video or any in an embodiment.

As used herein, the phrase “units” refers to the number of advertisement objects shown in the target area.

As used herein, the phrase “advertisement object” can refer to an advertisement object with attributes. The attributes include a plurality of ad objects, target area, keywords, content type, display attributes, etc. The ad objects include attributes name, id, description, count thresholds, image, motion, video stream, keywords, target area, etc.

As used herein, the phrase “a bundle” can be an advertisement object with attributes on the client device. A bundle is a wrapper object for the server side advertisement object. A bundle includes all server side advertisement object attributes including layout, units, content-type, target area type, bundle id, next tick and adds new attributes for the client device like program code to be executed on the client device, display attributes like length, width, color, etc. The bundle enables the retrieved server side advertisement objects to be connected and acted upon with methods similar to server side methods but on the client device.

As used herein, the phrase “feedback input” can comprise feedback generated using human intelligence or through machine or artificial intelligence. Feedback input can be in the form of identifying the objects or events in an event stream and recording the start/end timeline of the events/objects/actions, etc., generating an id and adding tags identifying/prioritizing the events/objects and actions in the event stream at that particular time. The feedback can have an action associated with the event or object. For example, if the event is a movie preview, and at the end of the preview, the movie title or actors in it can be made sticky so that tickets to the movie can be shown. Sticky in an embodiment means prioritize search results to show the feedback which maybe tickets to the movie, overriding other matching results, etc. The feedback can also be a sensory input/output associated with the events in the event stream. In an embodiment feedback can be generated with human intelligence by watching or hearing or playing the event stream with a timeline. At interesting events in the event stream timeline, for eg. a home generated movie stream showing the busy streets of San Francisco, feedback can be input identifying objects in the event stream, like hotels, landmarks, people, etc. while also including the timeline when the identified objects are in focus in the event stream and the duration of the focus. In an embodiment, the feedback can be start time, end time, and relevant text identifying the scene or object. This feedback is generated for the entire stream identifying interesting scenes, objects and events. Once the feedback for an event stream is available, if the event stream is played back by another user or a plurality of users, advertising or content relevant to scene, objects and events in the event stream can now also be streamed to the client device. For eg. If the user is watching the streets of San Francisco, hotels/activities/vacation ideas can be streamed on to the target areas on the client device. The timer means on the client device is used to keep track of the timeline of the stream and is also communicated back to the advertisement server device. The advertisement server device on receiving a request with a time tick, matches the tick to the feedback timeline and uses the feedback input to search through an index matching content relevant to the timeline events. The server device sends back the matching content to the target area and maybe including the next tick when the client device is to communicate with it, enabling the sent back content to be rendered in the target area until the next tick. In an embodiment the specialized client application streaming the event and the advertisement server are synced with the timeline so that any noisy conditions—such as wireless connections—leading to dropped connections, frames, etc. can be handled. This sync also enables user interaction with the specialized client application such as pause/replay/rewind/fast forward, etc. to sync the timeline with the advertisement server device. The content can be text, graphics, media, games, puzzles, surveys, etc. Sending back games or puzzles or forms at time intervals allows the user to now interact with events in the event stream increasing the experience, brand awareness, complete a sale, etc. The input from the text/graphics/game/puzzle/form, sensory inputs, etc. can now be sent back to a server device for further processing. In an embodiment if the feedback is sensory then content or signals can be sent back to the target area enabling a sensory context to be triggered on the client device. In an embodiment the target area can be outside of the player event stream wherein the event stream may need to be played in a specialized client application. In an embodiment the target area can be inside the player streaming the event stream overlaying the event stream. In another embodiment the target area can be within an event stream wherein the event stream will need to be re-encoded including the advertising content in real-time or maybe statically. In an embodiment, the event and feedback can be in real-time enabling machine intelligence or human intelligence to generate feedback on the fly enabling contextual advertisement and actions to be sent back to the client device. In an embodiment the machine intelligence maybe speech or image recognition system or a combination that generates a stream of natural language text that is parsed into contexts using a NLP engine. The contexts are encoded into a timeline that becomes the feedback input for the event stream. The feedback can be enhanced to prioritize events or add actions, etc. In another embodiment, the feedback on the server side can be generated using artificial intelligence/machine learning to learn features of interesting objects and store them as sensory inputs into a knowledgebase. The machine learning steps for example in an embodiment to identify a visual objects in a frame/image maybe to extract features and keypoints using heuristics to make the features invariant to illumination, scale, rotational, occlusion, color, texture, etc., mapping the features to n dimensions to cluster and generate visual words which are then indexed and stored. On receiving sensory input from a client device, the server device may extract invariant features from the sensory input, cluster it n dimensions, extract visual words and search through the index to find similar matches to the sensory input and return entities associated with the sensory input as a response back to the client device.

As used herein, the phrase “events or objects or scene” in an event stream or media stream can be the actual events being shown in the stream. For example, buildings in downtown San Francisco or the wharf or golden gate bridge or the park, maybe a hotel, restaurant, etc or a sports events like golf wherein a known golfer is playing golf at a well-known course, etc.

As used herein, the phrase “events stream” is the media stream being streamed from a server device and can be in various formats. Media stream formats examples are flash, mp3, mp4, windows media, quicktime, mpeg4, h.264, Ogg, etc. In an embodiment the event stream is streamed with a specialized application player in a browser.

As used herein, the phrase “context” can refer to entities, actions, and the like, in an event stream wherein said entities, actions, etc. can be used to identify the event stream. In an embodiment it can be derived by identifying a sentence and parts, sense tagging it using a sense tagger to associate compound words, associate nearby words by looking through a known index, throwing away adjectives and keep just nouns and verbs, generate synonyms for the associated words to expand feedback generated, etc. In other embodiments, it can be derived pictorially by a frame or associating a sequence of frames of an event stream, identifying entities in that stream by transforming, extracting features, etc. to identify the scene of the event, entities involved in the scene like people, objects, animal, etc.

A sense tagger is similar to WordNet::SenseRelate::AllWords open source tagger that allows terms to be tagged with a sense known to Wordnet. It finds the sense of each term related to the surrounding terms based on measures as in Wordnet::Similarity ie. Term sense disambiguation is the task of assigning a sense to a word based on the context in which it occurs.

WordNet® “is a large lexical database of English, developed under the direction of George A Miller (Emeritus). Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated with the browser. WordNet is also freely and publicly available for download. WordNet's structure makes it a useful tool for computational linguistics and natural language processing”.

As used herein, the phrase “passing through the known index” can refer to looking up a term with sense, maybe throwing away an adjective but looking up nouns, verbs, etc. in the known index or a knowledgebase such as a Wikipedia topic title and forming sub contexts or maybe adding new compound contexts such as “mortgage”, “loans” or “mortgage loans” or little people or small people as Lilliput or dwarfs or hobbits, etc.

As used herein, the phrase “client sensory input feedback” can refer to input sent from a client device to a server device. The sensory input can comprise graphics/haptic/motion/magnetic/electromagnetic/location, and the like. For example, a user on a client device may use haptic senses to crop an area of visual input that can be communicated back to the server device as feedback. The server device can take the input, match it in its knowledgebase and serve back an advertisement, game, puzzle or content that the user can consume as response feedback. The server to match the input may transform the input or map the feedback coordinates to its sensory input database, pick an entity; extract relevant features from the client feedback input, apply a heuristics to match the features to relevant entities in the sensory input database to send back content to engage the user on the client device.

### System

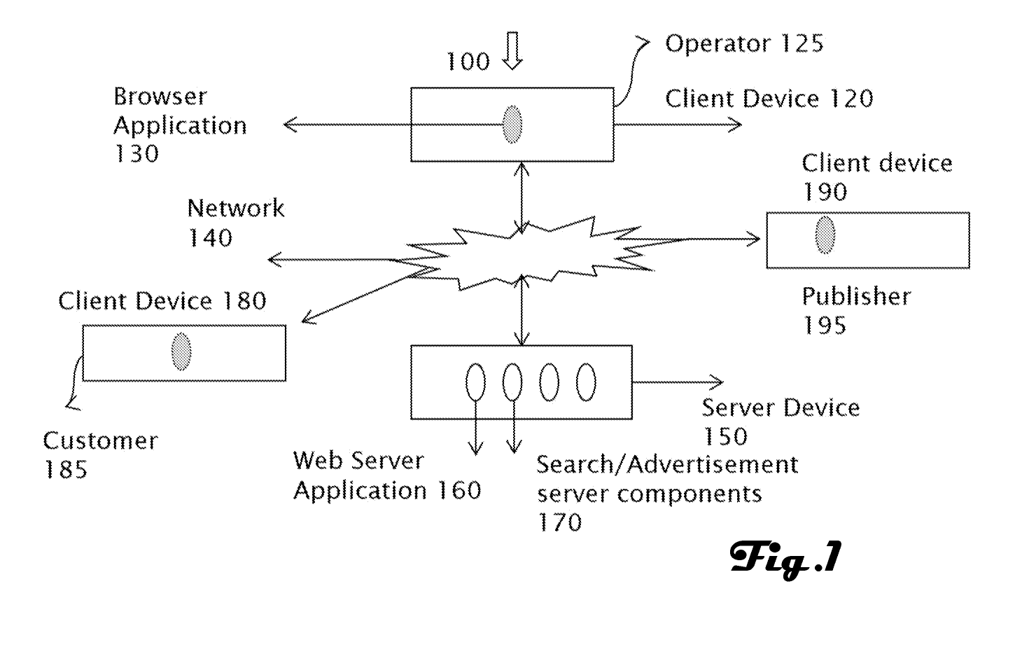

Referring to FIG. 1, an advertising system 100 according to one embodiment is illustrated. As shown in FIG. 1, the advertising system 100 can comprise a client device 120, a server device 150, and an operator or user or viewer of the client device 125. The operator can use the client device 120 and a browser application 130 to access a server device by typing the address of the server device into the browser input. The browser communicates request to the server device 150 across the network 140. The server device 150 sends back content to be rendered on the browser.

In an embodiment, HTML content is returned by the server device. The HTML content includes advertisements to be shown on the display device. The advertisements can be made up of HTML tags, program code and data objects. The program code is loaded through the JavaScript <script> tag with the src attribute pointing to the JavaScript file to be loaded from the server device. The data objects are again loaded using a JavaScript <script> tag with the src attribute pointing to the server device and taking as parameters a target area identifier, query terms, affiliate id, keywords, and the like

The program code checks if the data objects have been loaded and if so, renders the first data object on to the target area on the display using the size, width, color attributes, and the like. The data objects of an advertisement are linked such that there is a cyclical structure, the first object pointing to the second, second to the third, and the last to the first in an embodiment. In other embodiments, the data objects can be a list, with a count of number of objects in the list. An index can then be used to access the list.

The program code also signs up with the timer service to be triggered at clock intervals. On a trigger, the program code checks the count threshold if it needs to refresh the display, and if so, gets a reference to the next object and makes that as the current object while rendering the attributes onto the display. The cyclical structure of the data objects and the continuous updates at trigger thresholds creates a visual perception of motion to the user or viewer of the display. In an embodiment, if the bundle has content generation by site-owner enabled, instead of rendering content, the program code only tracks performance of the target area and sends back the performance metrics in terms of clicks, impressions, etc. back to the server device. In an embodiment the motion attribute can turned off and streaming attribute enabled in the bundle, enabling the program code to communicate with the server device at every clock or at known clock ticks sending back the ticks to the server device. The server device on receipt of the tick, looks to identify the request id and see if the timeline objects related to the id are in memory. If these are not in memory, these are loaded from a storage device and a hash structure created to match the tick to a timeline and the associated input feedback. Once a feedback input is matched, the server device uses the feedback input to search through an index and returns the matched advertisement data objects back to the client. The server device also includes the next trigger tick from the timeline for the client device to communicate back. The program code on receipt of the data objects on the client device now switches the current objects in the target area with the sent data objects. It also sets itself to communicate back to the server device at the next tick as sent by the server device.

In an embodiment, advertisements are added to HTML content being sent from a server device using a server side program code such as Java. In such an embodiment, the server device which has received a request from a client device with query terms, client attributes, and the like as parameters uses an established connection to an advertisement server including the said parameters, a target id, and the like and requests advertisements. The response from the server which is in the form of XML or JSON is converted to server side program code data objects using a data converter. The converted data objects are linked such that there is a cyclical structure, the first object pointing to the second, second to the third, and the last to the first in an embodiment. In other embodiments, the data objects can be a list, with a count of number of objects in the list. An index can then be used to access the list. The server side program code in the language manipulates the different attributes using the object methods to convert attributes into plain HTML tags and mixes it with the HTML content being sent across to the client device. The mix includes program code to be executed on the client device. The program code gets executed on load by the browser in an embodiment enabling the program code to sign up to be triggered on a clock signal. On a trigger, the said program code makes an XMLHttpRequest to the said server device. The server side programming code that is keeping track of the data objects being shown in a target area changes the current object to the next object if count thresholds are crossed. The object methods are manipulated again to convert the object attributes to HTML which is sent back to the client device, and the program code on the client device renders the HTML sent back onto the display device. The cyclical structure of the data objects and the continuous updates at the trigger thresholds creates a visual perception of motion to the user or viewer of the display. In an embodiment, if the bundle has content generation by site-owner enabled, instead of rendering content, the program code only tracks performance of the target area and sends back the performance metrics in terms of clicks, impressions, etc. back to the server device.

In an embodiment, advertisements are sent as data objects along with program code back to the client device. The program code on execution establishes a Server push type connection to the server device. It also signs up with the timer service to be triggered at clock signals. The clock signal trigger as before enables program code to render the data objects onto the display. But after a pre-configured number of iterations, the client code makes a request back to the server device for new set of data objects and the server device responds by sending a new set of data of objects and maybe program code. In other embodiments instead of the program code making a request for new objects, the server device which is keeping track of time on the server side sends back more data objects and maybe program code to the client device allowing the program code to change the data objects being refreshed onto the display with the new data objects received. This type of functionality allows a viewer of the client device to continuously see new data objects on the client device display.

In an embodiment, a media stream object is streamed with a specialized client application in a browser from a server device and the timelines of interesting objects, events, actions are noted using human intelligence. Tags are added to the feedback input to prioritize/identify events/objects, add indicators or sensory feedback. The tags are parsed at search time so as to override the search results, prioritize an advertisement data object or send back a known advertisement data object with an action such as movie theater tickets or a fashion gown at a discount or a jewelry on sale, etc. In an embodiment, the media stream object's audio stream is separated from the video stream on the server device and the audio stream is sent through a speech recognition system or service to transcribe the audio. The transcribed text is sent through a NLP processor with a sense tagger. The output of the sense tagger is next analyzed to identify contexts in the natural language text by looking up groups of words in a knowledge source such as wordnet, wikipedia, separate adjectives, form compound words such as combining “small people” to “small people” and generate synonyms such as lilliput/hobbit, etc., add time lines to the sentence or a paragraph to generate the feedback. The end output is meaningful keywords or contexts that can be used to identify events/objects/actions so that contextual advertisment objects can be matched and sent back to the client device. In an embodiment, the events/objects can be associated with a database such that actions can be associated to the object so that a movie object can have tickets associated with it or an entity identified in an event can have a sale object associated, etc. In an embodiment, the feedback file location is read at start up by the advertisement server application. A request from a client device with the stream id, clock ticks and/or user identifier parameters will enable loading the feedback associated with the stream into a hash and tree structure and a lookup is made into the data structure to match the timeline, extract the context/keywords with tags and a search initiated to match advertisement data object objects to return back to the client device. The response from the server device in the form of program code and data objects and display tags which maybe HTML in an embodiment are then rendered as before in target areas on the client device. The program code using the timing mechanism is in sync with the specialized client application and the event stream timeline in an embodiment using an api of the client application enabling advertisement objects to be shown within target area in the client application as well as target areas surrounding the client application. Mixing the advertisement dynamically on the client device enables contextually relevant advertisement to be shown not only within the specialized client application but also outside of it enabling richer monetizing opportunities and for the length of the media stream in real time. Even if the advertisements are turned off within the client application with a turn off mechanism or disabled, the timing mechanism and the program code enable context relevant advertisements to be streamed in real time from the server device to be shown in the surrounding target areas. In an embodiment the program code streaming the advertisement objects makes request back to the server device for more objects and the said server device can be the same device as the one sending back the media stream objects to the specialized client application or a different server device but within the same domain. In another embodiment, the program code streaming the advertisement objects can make requests to a server device that is on a different domain as to the server device streaming the media stream to the specialized client application. The timing mechanism and the program code still enable communication between the specialized client application to show contextually relevant advertisement objects to the media stream in target areas within the specialized client application or outside of it. In this embodiment the request/response is stateless allowing scalability on the server side to handle a plurality of such requests. In other embodiments, the request/response maybe stateful so as to provide a specific experience to a user on a client device.

In an embodiment, instead of speech recognition, an image recognition system can be used to identify objects/events/face, etc. so as to generate the feedback. In other embodiments, a combination of image/speech/human recognition can be used to generate the feedback. In an embodiment the feedback can be dynamically generated from a live stream and communicated to the advertisement server application. In an embodiment, the timing mechanism and program code enable personalized information/location, etc. to be sent back to the server device enabling contextual relevant personalized/location sensitive/cultural/seasonal/relevant advertisements to be sent back.

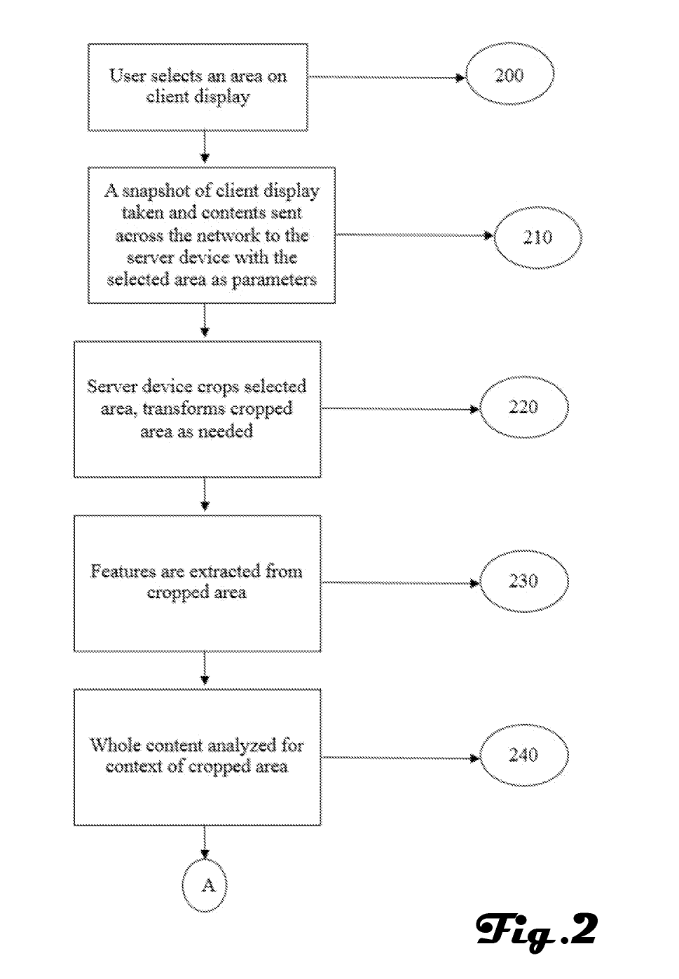

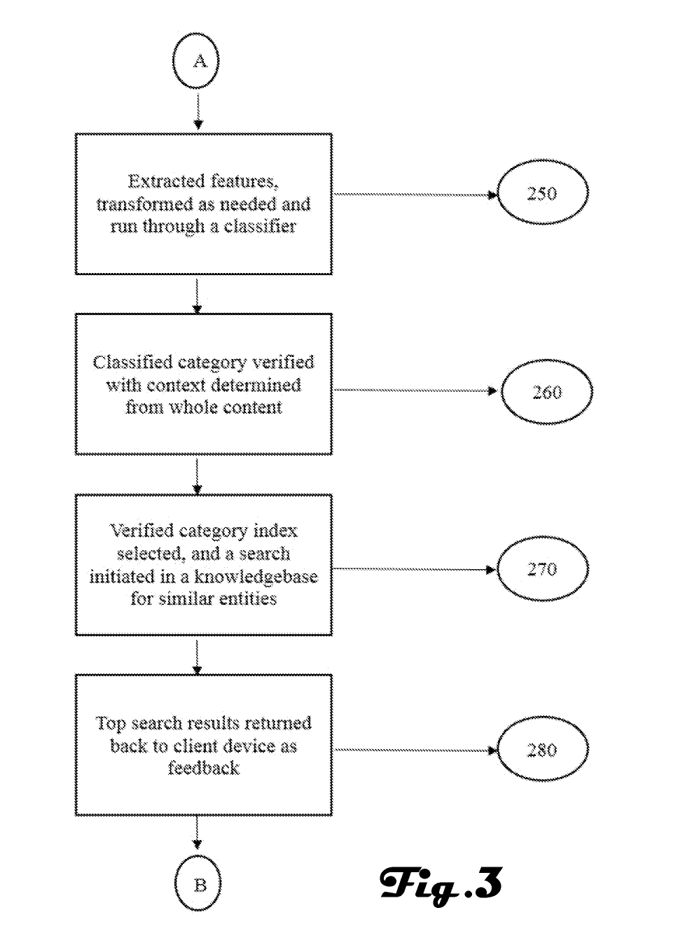

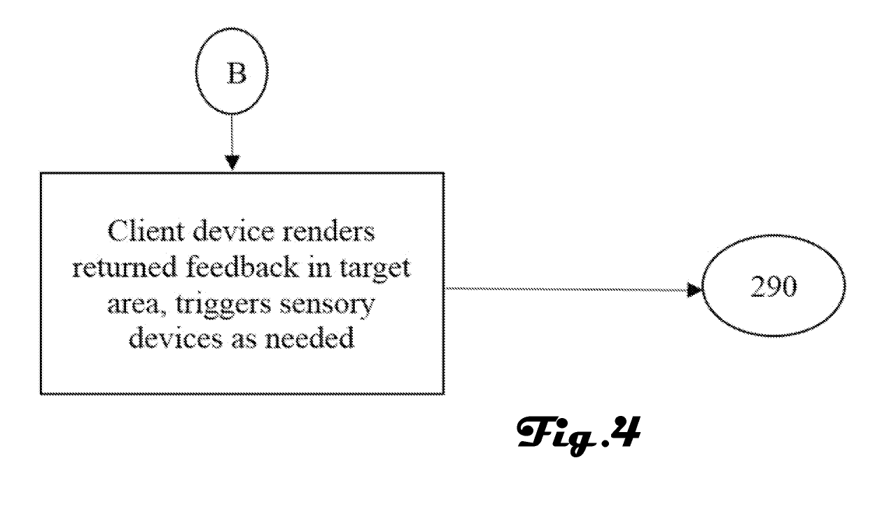

In an embodiment, a sensory device can be used to select an area on the client device either by swiping or gesture or thought, etc., crop the selected area and communicate the cropped area along with client device contents as feedback to the server device in an embodiment. The server device can transform the input, extract features from the input and use its knowledgebase to match entities that are similar and send back the entities as a feedback response to the client device, which can present the response to the user by rendering or similar to interact with the user. FIGS. 2, 3 and 4 show a user selecting an area on the client device for interaction. The client application marks the area selected and communicates a snapshot 210 of the contents of the client display to the server device along with the selected area co-ordinates as parameters. The server device reassembles the contents as on the client device, crops the selected area, transforms it as needed by resizing, scaling, etc. 220 and extracts features from the selected area using a heuristics 230. Next the content as a whole is analyzed to determine the entities involved 305 and to determine a context 240. For example, detect a scene, see if there are people in the scene, if so, determine the person object co-ordinates, next determine the parts of the person object like face (hair, eyes, nose, mouth), hands (arm, palm, fingers), body (above waist, below waist, neck), legs (foot, knees, ankle), etc. 240. Next the extracted and transformed features for the cropped area are run through a classifier to classify the cropped object 250, and the classification category is verified by associating with the context determined from the whole content 260. For eg. if a person object is detected and the cropped entity is classified as a handbag of a celebrity, the person object context is checked to see if the handbag is in the vicinity of the handbag region using heuristics, if so, the classified category index is searched in the knowledge base 270 for similar entities and the top most similar entities are selected and returned back to the client device as server feedback 280. The client application receives the feedback and renders the server feedback response in the target area on the client device and activates any sensory feedback associated to communicate the response 290.

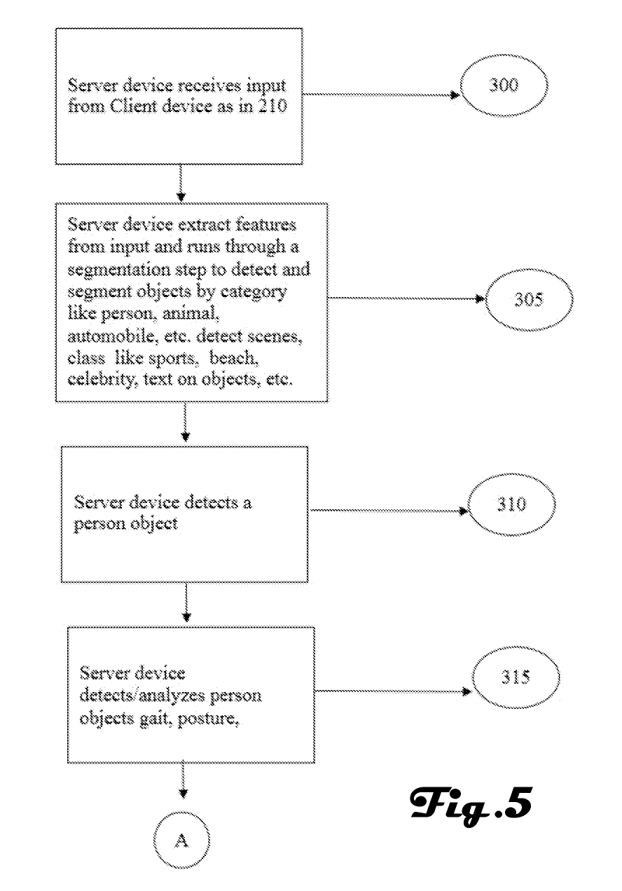

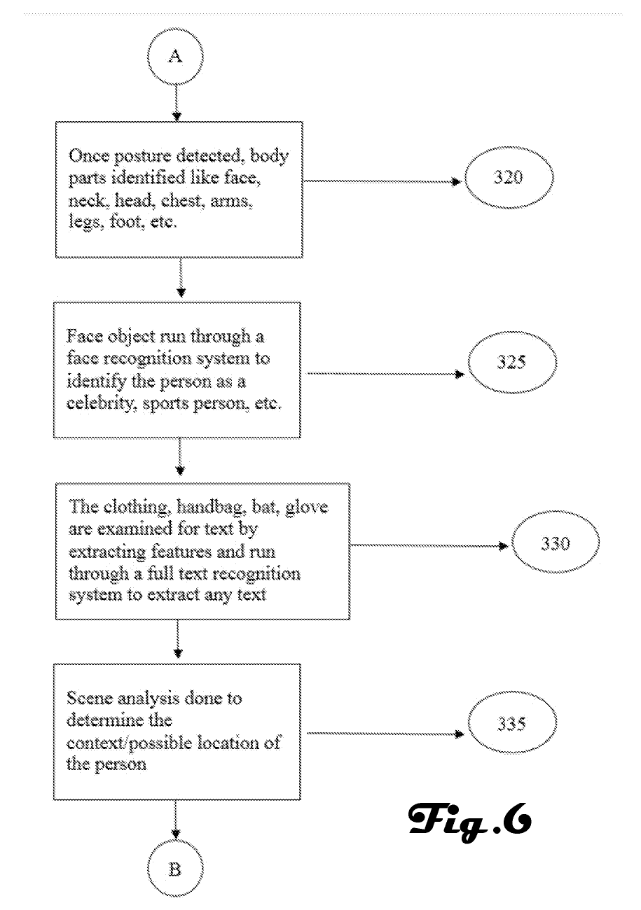

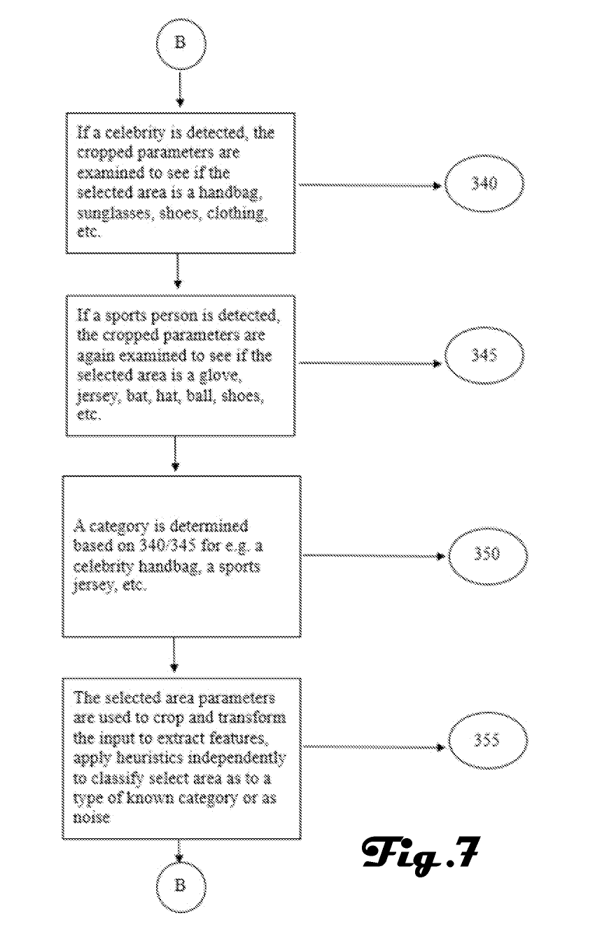

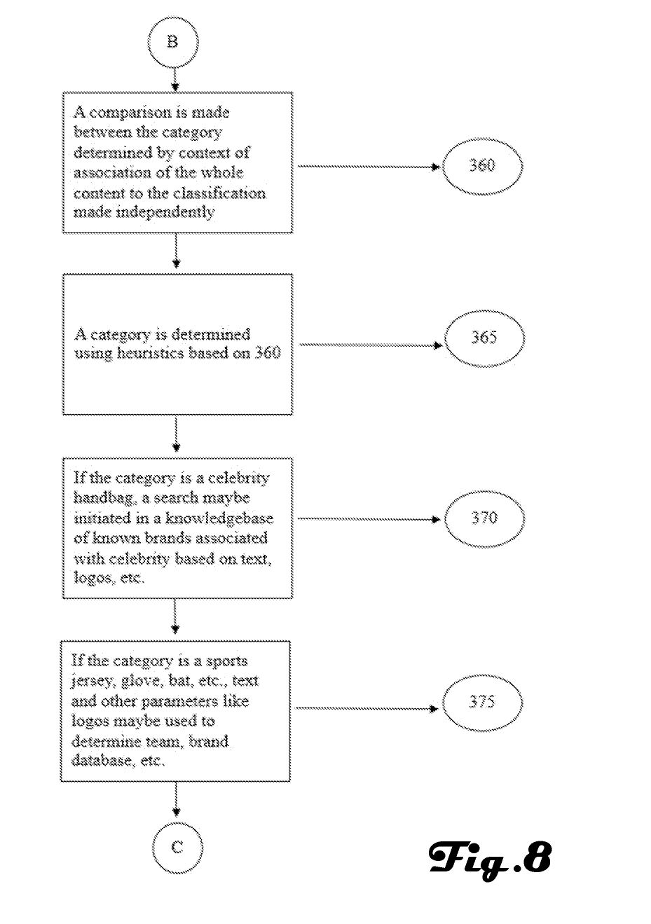

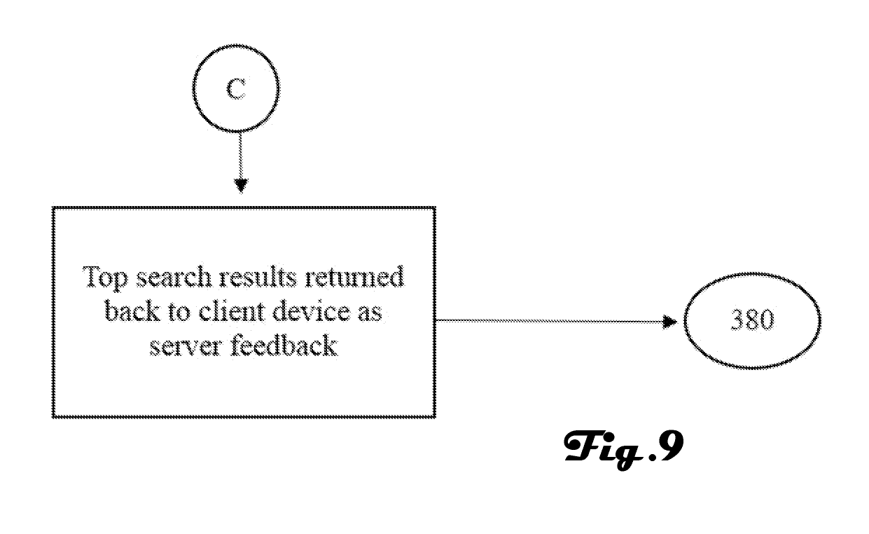

FIGS. 5, 6, 7, 8 and 9 illustrate an embodiment of the processing on the server device. 300 illustrates receiving of input on the server device after a user has selected an area on the client device. The server device transforms the content and extracts features which is sent to a segmentation step 305. The segmentation step may semantically segment the different objects in the picture to identify person, animal, car, etc. type of known objects. The features may also be sent to a scene analyzer to determine the scene of the content like a sports scene, beach, celebrity, etc. Text and logos may be extracted to understand the context more. For eg. if 305 detects a person object 310, the person maybe cropped and analyzed for gait, posture and body parts, 315, 320. The body parts like face maybe analyzed, transformed further to extract more features, etc. to recognize the face 325 if it belongs to a celebrity or a sports person, etc. The body parts may be further examined to extract any text/logos, dress, pants, jerseys, handbags, sunglasses, etc. 330. Scene analysis step maybe invoked to determine the context of the person, for example, a sports person playing baseball, etc. 335. The selected area co-ordinates are analyzed to the location of objects like handbags, sunglasses, a baseball glove, shoes, jewelry, jersey, clothes, etc. to determine a possible category/context of the selected area, 340,345. Next the selected area is cropped and transformed independently as needed, and features extracted to run through a classifier to classify the possible class or as noise 355. The independently classified class in 355 is compared with the class determined in 350 using a heuristics to determine the possible classification 360 of the object in the selected area. The classified category 365 for eg. a celebrity handbag is next examined for logos, text, etc. and if a celebrity has been recognized using face recognition to associate a brand database to find similar object used by the celebrity 370. If for example, it is a sports jersey or a baseball bat, if the sports person is identified through face recognition, again a brand database associated with person is used, if not team, jersey logos, etc are examined to determine the context/team of the sports person so that similar objects maybe retrieved 375. A search may also be made in a category index to identify similar objects. The most appropriate results along with any feedback are next selected with a heuristics to send back the response to the client device as server feedback 380.

In other embodiments, the user may start the interaction with the client device, which communicates with the server device which on analyzing may send back response feedback enabling and guiding the user selection of an input area on the client device which can be communicated to the server device for processing.

In an embodiment, a deep convolutional neural network combined with statistical analyzers maybe used to segment, classify, recognize objects, etc.

While embodiments and an application example of this present systems and methods have been shown and described, it would be apparent to those skilled in the art having benefit of this disclosure that many more modifications than mentioned above are possible without departing from the inventive concepts herein.

In an embodiment, an operator of the client display viewing the advertisement data objects may click on a link or click on a target area enabling program code to be executed. The executed code enables the browser to request content from the server device in the click link attribute. In an embodiment, the request could transfer control to the content from the server device. In other embodiments, the request could be initiated using a new browser window allowing the advertisements and content being shown on the display to still be visible. In an embodiment, a click on a compare link enables the program code to enable the browser to request content from the server device in the compare link passing as parameters a compare id. The server device on receiving the request from the client device with a compare id, responds back with compare content to be displayed on the client display. In an embodiment the content on the client device can be game or a puzzle or a form enabling the user to interact with the content and send back inputs back to the server device. The server device on receipt of such input can transfer control or bring in new content or persist the inputs for processing.

### Advertisement Database

The advertisement data objects created by the customer using the client device are stored on a server side storage device. Each advertisement object is stored in a storage file or as a record on the storage device using a data source. The name of the storage file or key can include advertisement attributes campaign identifier and customer identifier allowing the advertisement objects to be grouped by campaign and customer. In an embodiment an advertisement can be stored as an object itself using an Object converter. The campaign objects are again stored as a storage file or as a record or as an object file. The name of the storage file or key can include the attribute customer identifier allowing the campaign objects to be grouped by a customer. The customer object is again stored as a storage file or as a record or object file. The name of the storage file can include the customer identifier.

The target area data objects created by the site-owner using the client device are again stored on a server side storage device. Each target area object is stored in a storage file or as a record on the storage device using a data source. The name of the storage file or key can include target area identifier, site owner identifier allowing the advertisement objects to be grouped by target area and site-owner. In an embodiment a target area can be stored as an object itself using an Object converter.

When the advertisement server is started, it reads the customer objects, and reads all the campaign objects and further reads all the advertisement objects in a campaign. It organizes the objects by target area, if specified and uses a tree type structure to sort the objects by fixed price and bid price objects. When a request from a client device is received, the target identifier allows the server to identify the tree structure to use. The fixed price type objects have priority over the bid price type and are sent back first. A request parameter includes the number of advertisement objects to be sent back. The id attribute is assigned a unique time stamp so that an advertisement can be tracked before it is sent. An accounting record is created on the server side of sending the advertisement object. The record includes id, advertisement object attributes, and client parameters, and the like. The server also keeps track of the objects sent back so as to not send the same objects again. If a fixed price type object daily limits or budget thresholds are crossed then the object is removed from the tree. If there are no more fixed price type objects to be shown, then the highest bid objects for the target area are shown first. If there are no bid objects, then objects with no specific target area are selected to be sent back. In another embodiment, if billing type is cost-per-time and the time has expired the next available advertisement objects are selected. If the request parameters include query terms such as city, product name, search terms, and the like, the server initiates a query match on an index and returns matching advertising objects containing the terms. In an embodiment this can be the name of the storage file containing the advertising object or a key containing the terms customer id, campaign id and advertisement object id. The server uses the key to search the tree for the advertisement object and adds it to the list of objects to be returned. In an embodiment, the server device at startup can also read from timeline feedback files, reading the time events and the input feedback so as to match incoming clock tick with a time event.

Each impression shown is accounted for on the server device and also on the client device. The display of an advertisement on the client device is kept track of by analyzing the log files to confirm that an advertisement was indeed shown by matching the server side timestamp id and timestamp id sent back by the program code on an advertisement display on the client device. Similarly a click on a target device or a link is accounted for from the log files by matching the ids.

A script is executed on the advertisement server daily that goes through the accounting records and log files to match and account for an advertisement shown, clicked, and the like. The performance information by advertisement object, campaign, and customer are generated by the script. A graphical user interface allows the customer to access and view advertisement performance including billing information from a client device. Billing a customer could be through a credit card, ACH, and the like

Although the present systems and methods have been described with respect to a preferred embodiment thereof, those skilled in the art will note that various substitutions may be made to those embodiments described herein without departing from the spirit and scope of the present disclosure. Object attributes, program code, and functions specified and described herein have been selected for clarity of exposition, and do not represent all possible transformations or combinations. Those skilled in the art will also note that although embodiments of the present disclosure have been described in the context of target areas, timing mechanism, object attributes, program code, display, client device, server device, and the like certain features or embodiments may also apply to other forms of advertising not shown or discussed.

While embodiments and applications of this disclosure have been shown and described, it would be apparent to those skilled in the art having benefit of this disclosure that many more modifications than mentioned above are possible without departing from the inventive concepts herein. The disclosure, therefore, is not to be restricted except in the spirit of the appended claims.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method of a user interacting with a client device comprising:
selecting, at the client device, one or more co-ordinates of an input area using a sensory device associated with the client device, the input area being associated with input contents;
communicating, to a server device, the one or more input area co-ordinates and the input contents;
transforming, at the server device, the input contents to extract one or more features and using the one or more extracted features to classify the input contents to a class of object;
searching, at the service device, a knowledgebase using the class of object to identify one or more similar objects;
sending, to the client device, response feedback to the client device comprising the identified similar objects and sensory input;
presenting, at the client device, the server response feedback.

2. The method of claim 1 wherein the transforming, at the server device, the input contents from the client device to extract features comprises:
transforming the input content
resizing the input content;
analyzing the transformed content by semantically segmenting the transformed content for different objects;
detecting a scene by analyzing the transformed content and;
further segmenting a portion of the semantically segmented transformed content to identify a posture, a gait, and one or more body parts;
forming a context based on the objects, the detected scene, and the one or more identified body parts;
matching and associating the co-ordinates with the context to generate a first classification of the input contents,
transforming and resizing the input contents to generate a second classification of the input contents;
comparing and applying a heuristics to the first and second classification;
selecting a final classification for the input contents based on the comparing and heuristics application;
selecting a server response feedback based on the final classification; and
sending the selected server response feedback to the client device.

3. The method of claim 2 further comprising:
associating in a database the final classification with the one or more identified body parts;
identifying similar content based on a matching of data within the database with the input content; and
returning the identified similar content to the client device as a portion of the server response feedback.

4. The method of claim 2 wherein the server response feedback comprises sensory input and similar content.

5. The method of claim 4 wherein the client device presents the sensory input and the similar content in response to a user interaction that generated the input content.

6. A method for searching in a computer based system comprising:
selecting an input area on a client device using a sensory device;
communicating, by the client device to a server device, input area contents associated with the input area and input area co-ordinates associated with the input area;
processing, by the server device, the input contents to extract one or more features of the input contents and classifying the input contents to a class of object based on the one or more extracted features;
searching, by the server device, a knowledge database to identify similar objects based on the class of object;
sending, to the client device, one or more identified similar objects and sensory input data as a server response feedback;
rendering, at the client device, the server response feedback.

7. The method of claim 6, wherein the transforming at the server device the input contents from the client device to extract features comprises:
transforming the input content
resizing the input content;
analyzing the transformed content by semantically segmenting the transformed content for different objects;
detecting a scene by analyzing the transformed content and;
further segmenting a portion of the semantically segmented transformed content to identify a posture, a gait, and one or more body parts;
forming a context based on the objects, the detected scene, and the one or more identified body parts;
matching and associating the co-ordinates with the context to generate a first classification of the input contents,
transforming and resizing the input contents to generate a second classification of the input contents;
comparing and applying a heuristics to the first and second classification;
selecting a final classification for the input contents based on the comparing and heuristics application;
selecting a server response feedback based on the final classification; and
sending the selected server response feedback to the client device.

8. The method of claim 7 further comprising:
associating in a database the final classification with the one or more identified body parts;
identifying similar content based on a matching of data within the database with the input content; and
returning the identified similar content to the client device as a portion of the server response feedback.

9. The method of claim 7 wherein the server response feedback comprises sensory input and similar content.

10. The method of claim 9 wherein the client device presents the sensory input and the similar content in response to a user interaction that generated the input content.
